(19) United States
(12) Patent Application Publication
(10) Pub. No.: US 2013/0006654 A1
(43) Pub. Date: Jan. 3, 2013

(54) MEDICAL EXPERT SYSTEM

(75) Inventor: Rene Hermans, Wapserveen (NL)

(73) Assignee: VALETUDO INTERPRES, Wapserveen (NL)

(21) Appl. No.: 13/513,674

(22) PCT Filed: Dec. 3, 2010
(86) PCT No.: PCT/NL2010/050815

§ 371 Date: Sep. 18, 2012

(30) Foreign Application Priority Data
Dec. 4, 2009 (NL) 2003912

(51) Int. Cl. G06Q 50/22

(52) U.S. Cl. 705/2

(57) ABSTRACT

A system and method for collecting and translating patient information has a data collection interface, the data collection interface including one or more fields of grouped information, presented in a first language understood by a patient and including locations for identifying selected information relating to particular symptoms or conditions of the patient, a data translation interface for translating the selected information from the first language to data in at least a second language, understood by a medical practitioner and a data presentation interface including a presentation of information in the second language including the translated data. The data is arranged in a manner to assist a medical practitioner in the diagnosis of a possible complaint.

### BACKGROUND OF THE INVENTION

1. Field of the Invention

The invention relates generally to systems for assisting patients in identifying their complaints and presenting them in an easily comprehensible manner to a medical practitioner. In particular, the invention relates to a system for translating a collection of symptoms and information into another language or into computer readable code.

2. Description of the Related Art

In the treatment of sickness, a primary factor is the ability of a patient and a medical practitioner to effectively communicate with one another. This may be affected by numerous influences including language, physical location, the ability of patients to express themselves clearly and the ability of a doctor to understand and fully appreciate the information presented. In general, the ultimate object of a consultation between a patient and a medical practitioner will be to achieve a diagnosis of any possible complaint that ails the patient and the identification of a suitable course of treatment. Without effective communication, this objective may not be fully achieved.

With the increase of foreign travel, many people find themselves in a foreign country when they or one of their family is taken sick. Communicating with a doctor in a foreign language in situations of stress has been recognized as a particular inconvenience. An alternative may be to use modern communication means such as telephone or internet in order to communicate with a doctor of intermediary in the patients preferred language. Communication in this manner is often difficult, especially from remote locations and is often limited in scope, since a visual examination of the patient is not possible and the consultation may be relatively unstructured.

Even in cases where a patient and medical practitioner consult directly in their own language, the ability to reach a reliable diagnosis may still be compromised. The number of recognized medical conditions is extremely high. Each such condition may be characterized by multiple defining characteristics. In general, a well informed doctor may only be fully familiar with a limited number of such medical conditions. For others, it may be necessary to consult literature or a colleague in order to compare the patient symptoms with the defining medical characteristics of the condition. This may add considerably to the overall time to reach a diagnosis. The ability to recognize unfamiliar conditions is also affected considerably by factors such as previous and recent experience, work pressure, patient compliance and the like. Given the ever increasing pressure to become more efficient, less time may be available for consultations. Furthermore, due to increasing mobility and urbanization, medical practitioners may be less familiar with their patients and may be exposed to a greater variety of conditions in their every day practice.

A number of devices have been proposed to assist practitioners and medical personnel in the registration and management of patient information. In particular, expert systems exist which a practitioner may use in order to assist in identifying a course of treatment. One expert system is known from U.S. Pat. No. 5,517,405 in which a user may input information relating to a diagnosis and a proposed solution. The system assists the user in identifying possible courses of action by retrieving additional data, formulating questions and factoring in further user information into an interference engine in order to arrive at a recommendation. The system requires interaction by a medical practitioner in order to first diagnose the patient and is not directed to facilitating patient input. There is also no teaching of any form of assistance in reaching a diagnosis based on such patient input.

Another expert system is described in US 2003/0135393 in which a patient medical report may be associated with an expert consult request form or with a pharmaceutical product report. The patient medical report may comprise information stored in a database on server processing elements. The information may be based on previous patient history and laboratory tests including patient diagnoses and prescriptions. If an expert consultation is desired, this may be selected by a user whereupon details from the patient report will be retrieved and the expert information will be populated into an expert consult request form. This form may be transmitted to an expert processing element which can respond to the consultation using an expert system such as an artificial intelligence application having a knowledge base of medical expertise. There is no facility provided for patient input or interaction.

Despite the presence of such systems, investigations have shown that general practitioners during a first consultation with a patient having a medical condition may make a fully correct diagnosis in only 50% of the cases. In other cases, a patient may need to return a number of times or may require further referrals before a correct diagnosis is achieved. A period of many months may pass, which for rapidly progressing conditions may have detrimental consequences.

Further studies during post-mortem procedures have revealed that cause of death is often incorrectly diagnosed on death certificates and must be significantly revised after autopsy. Other post mortem studies have revealed further important and unexpected discoveries that would have been significant factors in the death of a patient. The underlying principle of diagnosis is based on initial fact finding followed by comparison with known diagnostic profiles for existing medical conditions. It is generally recommended that the initial fact finding takes place in a manner that is as objective and unbiased as possible. Nevertheless, it is inevitably the case that certain prevalent or obvious characteristics may influence the initial fact gathering. It would therefore be desirable to provide a system that encouraged objective fact finding in a structured manner.

According to a further disclosure of U.S. Pat. No. 5,444,192, there is provided an interactive data entry apparatus that can capture data entered via a paper entry form at its point of entry and convert it into a form compatible with a data processing system. The apparatus is able to detect an optically readable identification code provided on the form. This allows the apparatus to access information about the form in order to properly interpret entries. The data may be entered by a medical practitioner during a face to face interaction with a patient. The apparatus may provide feedback and recommendations based on data entered.

Although the above electronic systems may assist practitioners in recording and processing information, they do not address the initial hurdle of communication between a practitioner and a patient. In particular, by providing additional technology only to the practitioner they may even further distance the practitioner from the patient.

There remains a particular need for systems and methods that assist a patient in better communicating their complaints or disorders to a medical practitioner. Additionally, there is a need for a system that assists a doctor or medical practitioner in reaching a timely diagnosis, in particular by eliminating unlikely disorders and suggesting more probable disorders.

### BRIEF SUMMARY OF THE INVENTION

The present invention addresses these problems by providing a system for collecting and translating patient information, comprising: a data collection interface for patient input, the data collection interface comprising one or more fields of grouped information, presented in a first language understood by a patient and including locations for identifying selected information relating to particular symptoms or conditions of the patient; a data translation interface comprising an arrangement for translating the selected information from the first language to data in at least a second language, understood by a medical practitioner and/or expert system; and a data presentation interface comprising a presentation of information in the second language including the translated data, the data being arranged in a manner to assist a medical practitioner in the diagnosis of a possible complaint. By providing the possibility of direct patient input in a language understood by the patient and in an easily visible presentation, the collection of relevant information is facilitated. Data can then be translated into a second language understood by the practitioner for further analysis in order to reach a diagnosis. The data in this context is used to refer to the selection of information chosen by the patient which may be considered as a sub-selection of all the information initially presented by the data collection interface. The data may also be translated into an electronically readable format for electronic processing and/or transmission as will be discussed further below.

According to a preferred embodiment, the data collection interface comprises one or more first templates and the data presentation interface comprises one or more second templates, aligned with the first templates at the translation interface, whereby selected information entered on the first template is directly transcribed as data to the second template. Most preferably, this can be achieved using a paper based system in which a first sheet of paper carrying information in a first language is overlaid onto a second sheet of paper carrying the same or similar information translated into the second language. The translation interface may be provided by a carbon layer or other appropriate transfer chemicals between the two sheets e.g. on the rear surface of the first sheet. The patient may select information on the first sheet using a pen or marker. Pressure applied to the paper causes marking of the second sheet at a corresponding position, representing a presentation of information including the translated data. On termination of the consultation, the sheets may be separated and each party has a copy of the consultation in their own language.

By providing standardized templates, any combination of first and second sheets may be made, allowing translation between any combinations of languages. Although a preferred embodiment may be envisaged using paper templates, a similar principle and format may be adopted using electronic templates, which may also function as displays. A patient may thus be provided with a first electronic template in a first language and a practitioner may be provided with a corresponding second electronic template in a second language. Input on the first template may be directly converted into an indication at a corresponding position on the second template.

In a further preferred embodiment, the second language comprises an alpha-numeric code. In the case of a template, these may be provided such that a given entry by a patient is also translated into an associated code. Such codes are more easily transmitted or entered into an electronic device than the description to which they relate. Using such codes, a completed template may be easily entered into an electronic device such as a mobile phone or computer by merely entering the sequence of codes. In particular, paper templates may be provided which not only transfer data from an upper sheet to a lower sheet but that also transfer data onto the reverse side of the sheet. By providing an appropriate chemical layer on both the front and rear surfaces of each sheet, data entries made on the front surface of the upper sheet may be transferred both to the underlying sheet and to the rear surface of the upper sheet on which the alphanumeric codes are provided. In this manner, translation into a second spoken language and into a code may be simultaneously achieved. The system may also comprise a transmission interface for transmitting the alpha-numeric code from a patient location to a diagnosis location, preferably in the form of an SMS.

In one preferred form of template, visual representations of the human body may be provided in order to facilitate the identification of pain and complaints. A patient may therefore mark the location of the pain on the paper or electronic template. This information may then be transferred via the translation interface to the presentation interface. Transmission may be accompanied by translation into appropriate code representative e.g. of the parts of the body being referenced. Other uses of icons and visual representations may be provided in order to make the representation of the patient's condition more visible and easily expressed. The visual representation of the human body may also be used to determine the grouping of information of information on the data collection interface. In this manner, an electronic template may adapt to initial information from the patient by presenting e.g. male or female related questions or questions more related to a particular anatomical region.

According to one particular embodiment of the invention, the system further comprises a memory comprising a plurality of diagnostic profiles, each diagnostic profile being associated with a particular pattern of data. The memory may be in the form of a database in which details of a plurality of conditions or ailments are recorded. The conditions may be associated with a plurality of items of data typical of such conditions. In particular, the memory may comprise details of as many as five hundred different medical conditions or more, each being associated with up to twenty five items of data or more. A practitioner may be able to remember directly around thirty such conditions with all their key symptoms but is unlikely to be able to fully remember all details of more than this number of conditions.

Preferably, the second language may comprise a computer readable code and the system may further comprise a processor for comparing the computer readable code with the diagnostic profiles in the memory and selecting one or more profiles that correspond to the data. In this manner, the system may be directly arranged to identify one or more diagnostic profiles that can assist in identifying a medical condition. Identification of a profile may take place by different processes. In one process, the processor may compare the data carried by the code with each of the diagnostic profiles in the memory and select the profile which has the most points in common. In an alternative process, weighting of different data may be used in order to more accurately select a profile, or to distinguish between cases where two data sets have equal points in common A further alternative process may use fuzzy logic to choose a best fit condition. The skilled person will know of various algorithms that may be applied to optimize the choice of most likely diagnostic profiles.

According to a further aspect of the invention, the system may comprise an electronic display which may provide the function of the data presentation interface. The processor may be arranged to also provide an indication of the one or more selected profiles on the display. As an example, the system may be arranged to display the three closest selections including an indication of the factors that led to the choice. Additionally or alternatively, the processor may be arranged to compare the one or more selected profiles with additional data stored in the memory and, on the basis of the additional data, define further information to be collected from the patient. This may be recommended where a number of possible diagnostic profiles are possible in the light of the initial data received.

In one embodiment of the invention where the patient and practitioner are remote from one another, the further information to be collected from the patient may be presented on a second patient display, which may be remote from the first display. This may be on a mobile phone as an SMS message or via a computer interface or the like.

According to one embodiment of the invention in which the data collection interface comprises a paper form, the data translation interface may comprises an optical scanning device arranged to identify patient input on the form and convert it into data in the second language. One such scanning possibility is provided by the anoto-grid system, using e.g. an Anoto digital pen. Other scanning principles may of course also be used using e.g. optical character recognition to recognize symbols.

The system may also comprise a locating device arranged to identify the location of the data collection interface, preferably by GPS, and transmit an indication of the location to the data presentation interface. This may be useful in correctly identifying patient position for access by emergency services or to locate the closest medical practitioner who should provide a consultation.

According to another aspect of the invention there is provided a method of collecting patient information and displaying data relating thereto, the method comprising: collecting data at a data collection interface, the data collection interface comprising one or more fields of grouped information, presented in a first language understood by a patient and including locations for identifying selected information relating to particular symptoms or conditions of the patient; translating the selected information at a data translation interface from the first language to data in at least a second language, understood by a medical practitioner and/or expert system; and presenting the translated data on a data presentation interface comprising a presentation of information in the second language including the translated data, the data being arranged in a manner to assist a medical practitioner in the diagnosis of a possible complaint. The method may be carried out using the system provided above and as described in the detailed description below.

### BRIEF DESCRIPTION OF THE DRAWINGS

The features and advantages of the invention will be appreciated upon reference to the following drawings, in which:

FIG. 1 is a perspective view of a first embodiment of the invention showing first and second templates overlying one another;

FIG. 2 is a partial view of the template of FIG. 1;

FIG. 3 is a view showing part of the reverse side of the first template of FIG.1;

FIG. 4 is an overview of an integrated diagnostic system according to the invention;

FIG. 5 is a representation of a display of the system of FIG. 4;

FIG. 6 is a block diagram illustrating operation of the system of FIG. 4;

FIG. 7 is a general overview of the system illustrating the various players and their interaction.

### DESCRIPTION OF ILLUSTRATIVE EMBODIMENTS

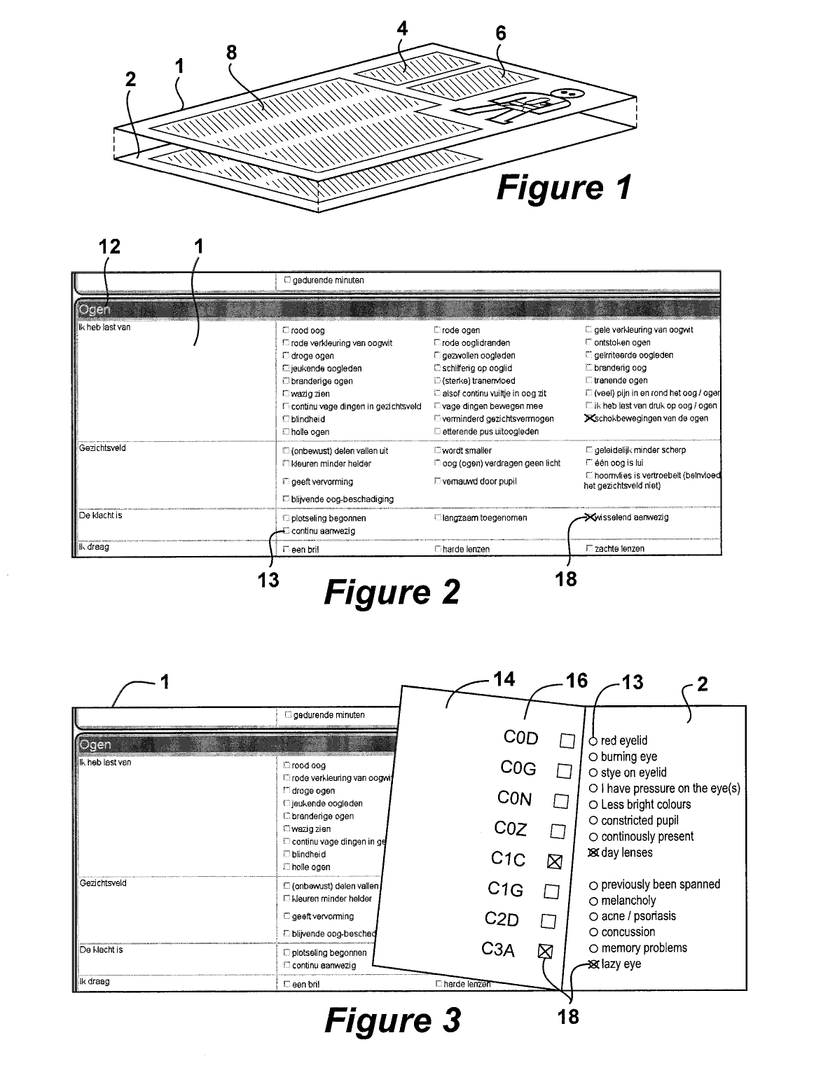

The following is a description of certain embodiments of the invention, given by way of example only and with reference to the drawings. Referring to FIG. 1, a perspective view is given of a first template 1 and a second template 2 placed in overlying relation to one another. The first template 1 contains a presentation of information in a first language. The information is present in four groups, namely general use of the form 4, general patient data entry 6, selectable information 8 relating to diagnosis of a medial complaint and a pictogram 10. The selectable information 8 is presented in a structured manner whereby questions relating to similar complaints or areas of the body are grouped into fields 12. Each item of selectable information is associated with a box 13 in which a mark may be placed. The second template 2 is essentially identical to the first template 1 except that it is written in a different language. Additionally, the general use information 4 may include specific information related to the country for which the form is intended.

The templates 1, 2 are made from paper and are provided with non-carbon copy (NCR) layers on their respective upper and lower surfaces. Various conventional NCR layers may be used. In the simplest form, the lower surface of the first template 1 is provided with a back coating and the upper surface of the second template 2 is provided with a front coating. Markings applied to the first template 1 are thus transferred by the NCR layers to the second template 2. According to an important aspect of the invention, the templates 1, 2 are also provided with a further coating in order to render the boxes 13 partially opaque. This coating, applied during printing, comprises a chemical coating of the type used to produce artificial watermarks. Despite the paper becoming opaque within the box 13, it can still be written on.

FIG. 2 shows in greater detail a part of the first template 1 of FIG. 1. The information is provided in the Dutch language and includes a field 12 specifically concerned with complaints of the eye. A patient using the template has marked with a cross 18 two boxes 13 that are representative of their complaint. FIG. 3 shows part of the first template 1 folded back revealing the second template 2 beneath. The information on the second template 2 is identical except that it is present in the English language. The marked items on the first template 1 are also marked with a cross 18 on the second template 2 due to transfer by the copying layer. Also visible is the rear side 14 of the first template 1. The rear side 14 is provided with alphanumeric codes 16 representing the selectable information 8 on the first template 1. As can be seen, the crosses 18 are also revealed onto the rear side 14 due to the opacity of the paper within the boxes 13.

In use, a person wishing to travel abroad may take with them a form comprising first and second templates whereby the first template is in the person's own language and the second form is in the language of the travel destination. Should a medical complaint arise whereby the person is required to visit a local doctor while abroad, the person may fill out the first template 1 at the consultation or in advance and hand the second template 2 to the doctor. The doctor receives a full overview of all the most relevant information relating to the patient and their condition in a language that they understand. The doctor may also ask additional questions in response to reading the second template 2 or may draw the patient's attention to further fields 12 that have not been filled.

In addition to a local consultation, the patient may also forward the alphanumeric codes to their own doctor in their home country via electronic means such as SMS. That doctor may also provide a diagnosis on this basis and may liaise with the local doctor should that be desired. The data may also be entered into an electronic expert system as will be described further below.

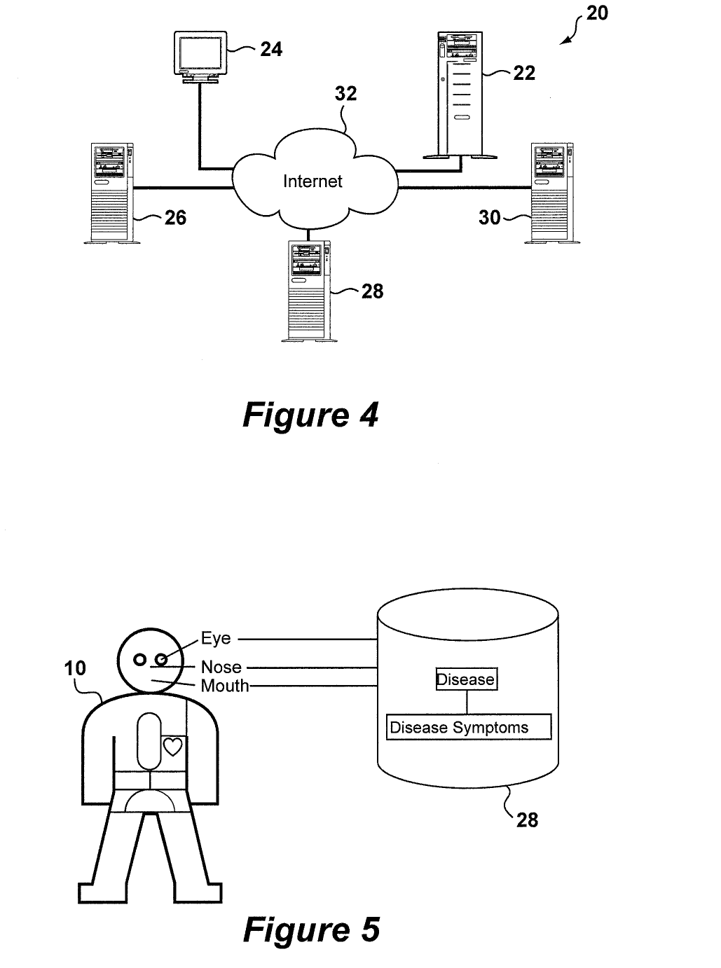

FIG. 4 shows an overview of an integrated diagnostic system 20 according to one aspect of the present invention. The system 20 comprises a number of elements that may be linked together by appropriate connections, in combination with the relevant software in order that they may correctly function together. According to FIG. 4 the system 20 comprises a hand held device 22, a terminal 24 having a display 25, a pharmacy system 26, a diagnostic server 28 and a doctor's system 30. All elements of the system are linked together via the internet 32. It is of course understood that such connection may be provided by conventional telephone connection or by any other appropriate communication means. It is also understood that any number of these elements may be present according to the size and number of users of the system. The diagnostic server 28 includes a memory 34 and a processor 36. The other elements of the system may be generally conventional in design and will not be discussed in further detail.

The memory 34 contains a database of all identified medical conditions. In the present case, more than 500 conditions are identified. The conditions are organized in the database in relation to their diagnostic profiles whereby a condition is associated with a plurality of items of data that are indicative of a given condition. The items of data correspond with the alphanumeric codes 16 and selectable information provided on the templates 1, 2.

A patient using the templates 1,2 of FIG. 1, whether abroad or in their own country may use a hand held device 22 to enter the alphanumeric codes 16 for transmission via the internet 32 to the diagnostic server 28. The processor 36 of the diagnostic server 28 can interpret the codes 16 on the basis of information contained in the database of memory 34 and can identify one or more possible conditions that have diagnostic profiles corresponding to the data received from the patient. The processor 36 may also forward the results of the diagnosis to a medical practitioner at the terminal 24, together with the full overview of data, based e.g. on the codes 16 received from the patient. The medical practitioner will then be able to see a similar version of the first 1 or second template 2 depending on their chosen language on the display 25. Both the diagnostic server 28 and the terminal 24 may be able to consult other sources of information such as the pharmacy system 26 and the doctor's system 30 in order to retrieve additional information where necessary.

Although the invention has been described in relation to manual entry of patient data, it will be understood that other electronic devices may be used that are capable of recognizing patient input or of reading a completed template. In particular, a scanning pen such as the Anoto digital pen may be used or a device such as that disclosed above in U.S. Pat. No. 5,444,192, the contents of which are incorporated herein by reference. Alternatively, the patient may use a terminal 24 to enter information on an electronic version of the first template 1.

FIG. 5 shows a representation of the interaction that may be provided between a terminal 24 and the diagnostic server 28 in the case of an electronic template 1. According to FIG. 5, after logging into the diagnostic program, the patient is initially presented with a pictogram 10 of the human body. By appropriate data entry such as keypad or touch-screen, the patient may indicate the location of the complaint. On the basis of this input, the diagnostic server 28 provides a selected group of questions related to information that is relevant to this location.

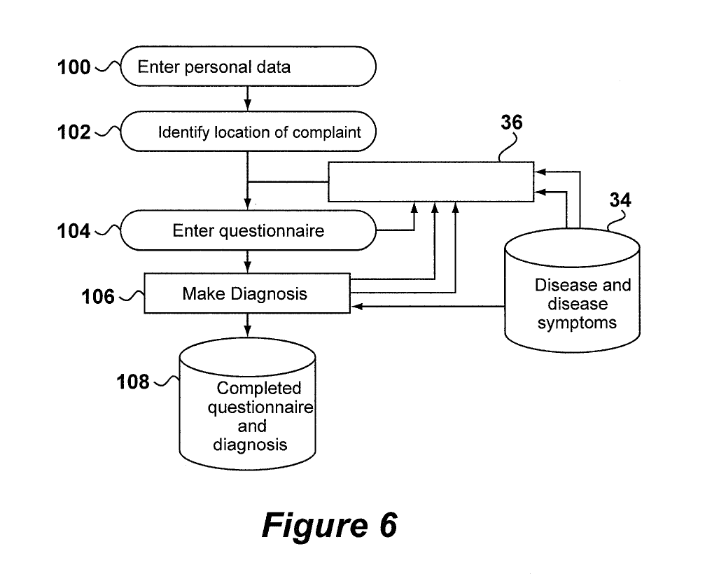

FIG. 6 is a block diagram illustrating the interaction between a patient and the diagnostic terminal 24. In a first step 100, the patient enters personal information in the form of general patient data 6 and any required authorization codes required to enter the system. At step 102, the patient identifies the anatomical region of the complaint. The processor 36 consults the database in the memory 34 and determines an appropriate group of questions to present to the patient. At step 104, the patient enters information in response to the questions and the processor 36 reacts to the questions by consulting the memory 34 for any further questions that should be presented to the patient. At step 106, the processor 36 identifies one or more possible conditions that have diagnostic profiles corresponding to the data received from the patient and generates a facultative diagnosis on the basis of this information. The completed template 2 and facultative diagnosis are forwarded to a medical practitioner or stored for later use at step 108.

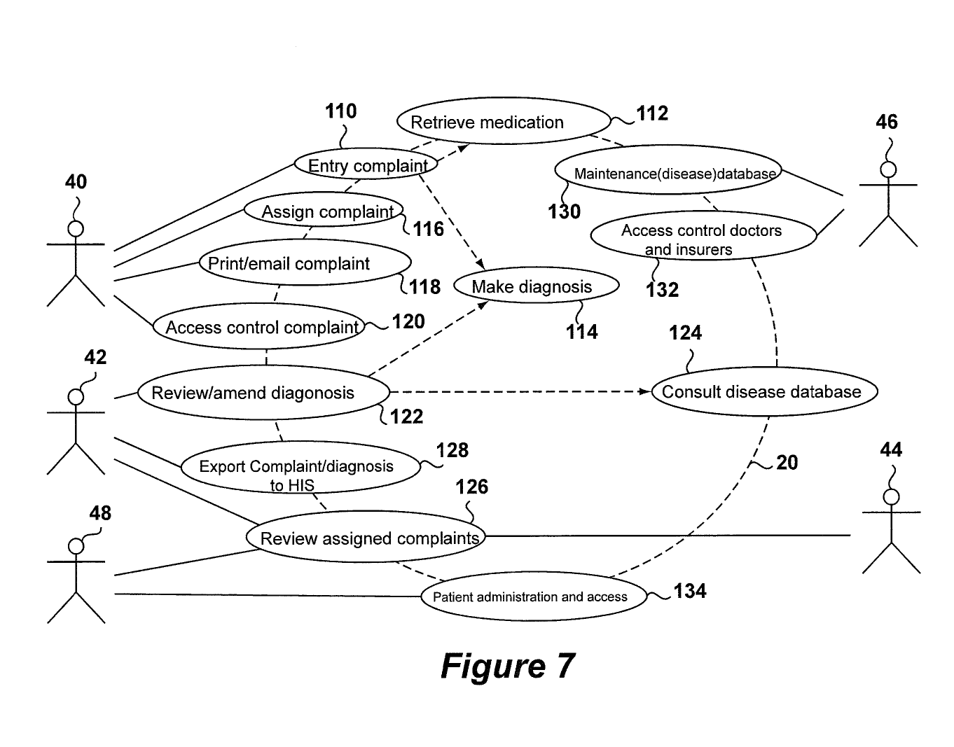

A general overview of the whole system 20 is given in FIG. 7 illustrating the various players and their interaction. A patient 40 enters data via a first template 1 at point 110. The diagnostic server 28 can retrieve medication data at point 112 from a pharmacy system 26 and can make a facultative diagnosis at point 114. The patient 40 can assign the complaint to a particular doctor at point 116 by identifying e.g. a house doctor, online doctor, specialist or local foreign doctor. The patient 40 at point 118 may also print and/or email the data from the first template to the chosen doctor or to another player. At point 120, the patient 40 may provide the data with appropriate security in order to ensure patient confidentiality.

If the chosen doctor 42 is admitted to the diagnostic system, he may review and amend the facultative diagnosis at point 122. This may be performed by accessing the doctor's system 30 at point 124 or by reviewing the entered data at point 126. He may also choose to export information to a hospital information system or the like at point 128.

If the chosen doctor is an anonymous doctor 44 i.e. not admitted to the diagnostic system, he may only gain access to review the entered data at point 126. This may be the case where the second template 2 is provided to the doctor 44 as a paper template or emailed electronically.

Additional players in the system are the system supervisor 46 and the insurer 48. The supervisor 46 has control over the database in the memory 34 at point 130. Additionally he is responsible for access for all parties at point 132. The insurer 48 (travel or health) may be provided access to the entered data at point 126 depending upon local laws and agreements over privacy and data protection. They may also determine whether patients have access to the system at point 134, depending upon the nature of the insurance policy.

Although the invention has been described by reference to certain embodiments discussed above, it will be recognized that these embodiments are susceptible to various modifications and alternative forms well known to those of skill in the art and that further modifications in addition to those described above may be made to the structures and techniques described herein without departing from the spirit and scope of the invention. Accordingly, although specific embodiments have been described, these are examples only and are not limiting upon the scope of the invention.

1. A system for collecting and translating patient information, comprising:
a data collection interface, the data collection interface comprising one or more fields of grouped information, presented in a first language understood by a patient and including locations for identifying selected information relating to particular symptoms or conditions of the patient;
a data translation interface comprising an arrangement for translating the selected information from the first language to data in at least a second language, understood by a medical practitioner and/or expert system; and
a data presentation interface comprising a presentation of information in the second language including the translated data, the data being arranged in a manner to assist a medical practitioner in the diagnosis of a possible complaint.

2. The system of claim 1, wherein the data collection interface comprises one or more first templates and the data presentation interface comprises one or more second templates, aligned with the first templates at the translation interface, whereby selected information entered on the first template is directly transcribed as data to the second template.

3. The system of claim 1 r claim 2, wherein the second language comprises an alpha-numeric code and the system comprises a transmission interface for transmitting the alpha-numeric code from a patient location to a diagnosis location, preferably in the form of an SMS.

4. The system of y p ceding claim 1, wherein the system further comprises a memory comprising a plurality of diagnostic profiles, each diagnostic profile being associated with a particular pattern of data.

5. The system of claim 4, wherein the second language comprises a computer readable code and the system further comprises a processor for comparing the computer readable code with the diagnostic profiles in the memory and selecting one or more profiles that correspond to the data.

6. The system of claim 5, further comprising an electronic display and whereby the processor is arranged to provide an indication of the one or more selected profiles on the display.

7. The system of claim 5, wherein the processor is arranged to compare the one or more selected profiles with additional data stored in the memory and, on the basis of the additional data, define further information to be collected from the patient.

8. The system of claim 7, wherein the further information to be collected from the patient is presented on a patient display.

9. The system of claim 1, wherein the data collection interface comprises a standardized form, preferably of paper.

10. The system of claim 9, wherein the data translation interface comprises an optical scanning device arranged to identify patient input on the form and convert it into data in the second language.

11. The system of claim 1, further comprising a locating device arranged to identify the location of the data collection interface, preferably by GPS, and transmit an indication of the location to the data presentation interface.

12. A method of collecting patient information and displaying data relating thereto, the method comprising:
collecting data at a data collection interface, the data collection interface comprising one or more fields of grouped information, presented in a first language understood by a patient and including locations for identifying selected information relating to particular symptoms or conditions of the patient;
translating the selected information at a data translation interface from the first language to data in at least a second language, understood by a medical practitioner and/or expert system; and
presenting the translated data on a data presentation interface comprising a presentation of information in the second language including the translated data, the data being arranged in a manner to assist a medical practitioner in the diagnosis of a possible complaint.

13. The method of claim 12, wherein the data collection interface comprises one or more first templates and the data presentation interface comprises one or more second templates, aligned with the first templates at the translation interface, and the method comprises directly transcribing selected information entered on the first template as data to the second template.

14. The method of claim 12, wherein the second language comprises an alpha-numeric code and the method comprises transmitting the alpha-numeric code from a patient location to a diagnosis location, preferably in the form of an SMS.

15. The method of claim 12, wherein the system further comprises a memory comprising a plurality of diagnostic profiles, each diagnostic profile being associated with a particular pattern of data and the method further comprises comparing the computer readable code with the diagnostic profiles in the memory and selecting one or more profiles that correspond to the data.

16. The method of claim 15, further comprising providing an indication of the one or more selected profiles on an electronic display.

17. The method of claim 15, comprising comparing the one or more selected profiles with additional data stored in the memory and, on the basis of the additional data, defining further information to be collected from the patient.

18. The method of claim 17, wherein the further information to be collected from the patient is presented on a patient display.

19. The method of claim 12, wherein the data collection interface comprises a standardized form, preferably of paper and the method comprises automated reading of the form to identify patient input on the form and convert it into data in the second language.

20. The method of claim 12, further comprising identifying the location of the data collection interface, preferably by GPS technique and transmitting an indication of the location to the data presentation interface.
